(19) United States
(12) Patent Application Publication
(10) Pub. No.: US 2013/0044859 A1
(43) Pub. Date: Feb. 21, 2013

(54) X-RAY IMAGING DEVICE

(71) Applicant: Katsuhiro YABUGAMI, Kyoto (JP)

(72) Inventor: Katsuhiro YABUGAMI, Kyoto (JP)

(73) Assignee: SHIMADZU CORPORATION, Kyoto (JP)

(21) Appl. No.: 13/210,044

(22) Filed: Aug. 15, 2011

(51) Int. Cl. G01N 23/04

(52) U.S. Cl. 378/62

(57) ABSTRACT

When performing an examination or a treatment that requires a high-quality image, the operator operates the foot switch with his or her foot, to increase the magnitude of depression of the foot switch. This increases the x-ray dose per unit time that is emitted towards the examination patient, making it possible to obtain a high quality captured image Or transparent image. In contrast, when, for example, directing a. catheter to a target position, the operator reduces the magnitude of depression of the foot switch by operating the foot switch with his or her foot. This makes it possible to reduce the dose with which the examination patient is exposed, by reducing the x-ray dose per unit time that is emitted toward the examination patient.

### CROSS REFERENCE TO RELATED APPLICATION

This application is based on Japanese Patent Application No. 2009-089264 filed Apr. 1, 2009, which is incorporated herein by reference. This application was published Oct. 28, 2010 as JP 2010-240028.

### FIELD OF TECHNOLOGY

The present invention relates to an x-ray imaging device, comprising an x-ray tube for emitting x-rays and an x-ray detecting device oriented facing the x-ray tube, for performing x-ray imaging by detecting x-rays that pass through an object to be examined.

### BACKGROUND OF THE INVENTION

in this type of x-ray imaging device, x-rays are emitted towards a patient, and thus it is necessary for the exposure to be as low as possible. Because of this, even though it is necessary to perform high-quality imaging with high x-ray doses at a high pulse rate when imaging important locations, it is important, from the perspective of reduced exposure, to select an imaging mode with low-exposure transmission, with a low image quality when, for example, guiding a catheter to a target location, because such high image quality is not required. Such conditions for imaging using x-rays arc modified through an operation by an operator.

In Japanese Unexamined Patent Application Publication H10-191166 (“JP '166”), an x-ray diagnostic device is disclosed wherein the x-ray imaging conditions are modified through the operation of an operating lever that is disposed on an operating handle. Moreover, in Japanese Unexamined Patent Application Publication 2006-271766 (“JP '766”), an x-ray transmission viewing device is disclosed wherein the x-rays are emitted while a foot switch is depressed, and in Japanese Unexamined Patent Application Publication H4-38082 (“JP '082) a digital angiography device is disclosed wherein imaging commences when a hand switch is pressed.

If, at the time of x-ray imaging, an operating lever is disposed at a position that is away from the imaging device, as set forth in JP '166, the operator will be unable to operate the operating lever. Moreover, in a situation wherein the operator is a physician and is performing a catheter treatment, or the like, both hands will be occupied, preventing operation of an operating lever, or the like.

In this way, in a conventional device, the operation of the operating lever, or the like, is complicated, producing a problem in that the high-quality mode wherein the radiological dose is high ends up being selected even when there is no need for such high image quality.

Moreover, while it is effective to use a foot switch or a hand switch, the foot switch and hand switch disclosed in JP '766 and JP '082 are, in the end, no more than means for starting the imaging.

The present invention is to solve the problems set forth above, and the object thereof is to provide an x-ray imaging device wherein the x-ray imaging conditions can be modified easily by the operator.

### SUMMARY OF THE INVENTION

An x-ray imaging device according to the present invention, including an x-ray tube for emitting x-rays and an x-ray detecting device oriented facing the x-ray tube, for performing x-ray imaging by detecting x-rays that pass through an object to be examined, includes detecting means for detecting, stepwise or continuously, changes in an operating quantity by an operator at the time of x-ray imaging; and controlling means for changing x-ray imaging conditions based on a detection result by the detecting means.

The invention as set forth below, where the detecting means are a foot switch or a hand switch for detecting a change in a pressing force or a magnitude of depression by an operator.

The examples below includes, where the controlling means change, stepwise or continuously, an x-ray dose emitted toward an object being examined, based on a detection result by the detecting means.

The invention includes the controlling means change, stepwise or continuously, a tube voltage of an x-ray tube, a tube current of an x-ray tube, a pulse rate of an x-ray, and/or a pulse width of an x-ray, based on a detection result by the detecting means.

An example of the invention as set forth below, where the controlling means use selectively a plurality of soft radiation excluding filters based on a detection result by the detecting means.

An example includes storing means for storing a plurality of x-ray imaging conditions, wherein: the controlling means select one x-ray imaging condition that is stored in the controlling means, based on a detection result of the detecting means.

The invention as set forth below, further has an image processing unit for displaying an x-ray transmission image on the image displaying unit using a video signal based on x-rays detected by the x-ray detecting device; wherein: the controlling means change a condition for image processing by the image processing unit based on a detection result by the detecting means.

The invention as set forth enables modifications to the x-ray imaging conditions based on detection result of detecting means that perform detection, either stepwise or continuously, of changes in an operating quantity by the operator. Because of this, when a high-quality image is not required, the mode wherein the radiation exposure dose is low can be selected easily, making it possible to achieve a reduction in the radiation exposure dose.

In the invention as set forth, a foot switch or a hand switch for detecting a change in a pressing three or a magnitude of depression by the operator is used, thereby enabling the x-ray imaging conditions to be modified easily through the operator operating the foot switch or the hand switch.

The invention enables the x-ray dose that is emitted towards the object to be examined to be changed, either stepwise or continuously, through the operator operating a foot switch or a hand switch.

The invention also enables the tube voltage of the x-ray tube, the tube current of the x-ray tube, the x-ray pulse rate, and/or the x-ray pulse width to be changed, either stepwise or continuously, through the operator operating a foot switch or a hand switch.

The invention can enable a plurality of soft radiation excluding filters to be selected for use through the operator operating a foot switch or a hand switch.

The invention enables the execution of x-ray imaging through the selection, through the operator operating a foot switch or a hand switch, of one x-ray imaging condition that is stored in storing means for storing a plurality of x-ray imaging conditions.

The invention further enables the modification of image processing conditions of an image processing unit in order to display an x-ray transmission image on an image displaying unit through an operator operating a foot switch or a hand switch.

### BRIEF DESCRIPTION OF THE DRAWINGS

FIG. 1 is a perspective diagram of an x-ray imaging device according to the present invention.

FIG. 2 is a schematic diagram illustrating a filter selecting unit together with an x-ray tube that are contained within an x-ray emitting unit.

FIG. 3 is a schematic diagram illustrating the structure of a foot switch.

FIG. 4 is a block diagram illustrating the electrical structures of an x-ray imaging device according to an example of the present invention.

FIG. 5 is a graph illustrating the relationship between the magnitude of depression of the foot switch, and the tube voltage and tube current.

FIG. 6 is a graph illustrating the relationship between the magnitude of depression of the foot switch, and the pulse rate of the x-rays emitted from the x-ray tube.

FIG. 7 is a schematic diagram of a hand switch that is used in an x-ray imaging device as set forth in another example according to the present invention.

### DETAILED DESCRIPTION OF THE INVENTION

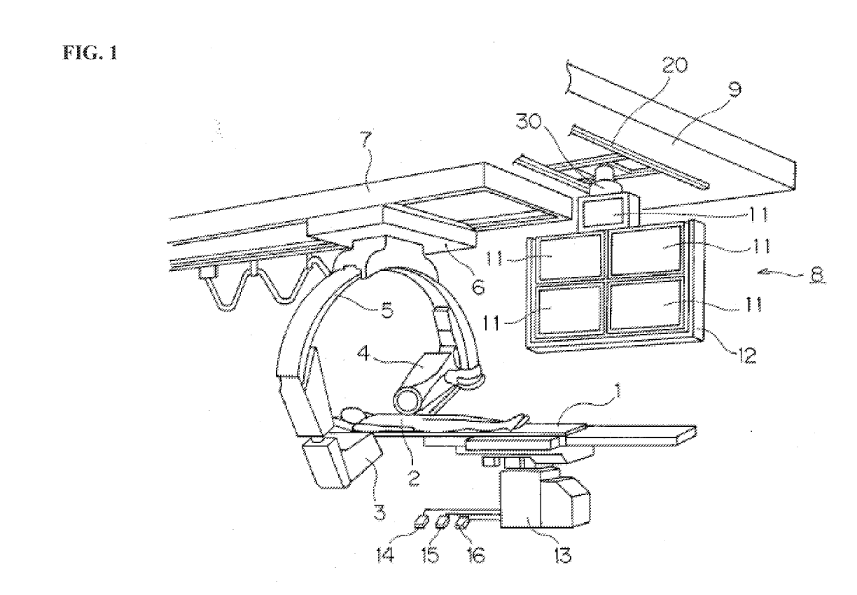

Examples embodying the present invention are described below based on the drawings. FIG. 1 is a perspective diagram of an x-ray imaging device according to the present invention.

This x-ray imaging device includes an x-ray emitting unit 3, provided with an x-ray tube 67 for which the details are described below, for emitting x-rays toward an examination patient 2, as the object to be examined, on an examination table 1, along with an x-ray detecting device 4 for detecting x-rays that pass through the examination patient 2. The x-ray emitting unit 3 and the x-ray detecting device 4 are held by an essentially U-shaped arm 5. This arm 5 is supported on a carriage 6 that can move in one direction through guidance by a guide member 7 that is secured to a ceiling 9. Moreover, an image displaying unit 8, provided with a plurality of monitors 11 and guard members 12, is suspended from the ceiling 9. This image displaying unit 8 is suspended by a suspending mechanism 30, and can move, guided by a rail 20 that is provided on the ceiling 9. Moreover, a plurality of foot switches 14, 15, and 16, for executing operations by the x-ray imaging device using the heat of the operator, are placed on the floor in the vicinity of a supporting portion 13 of the examination table 1.

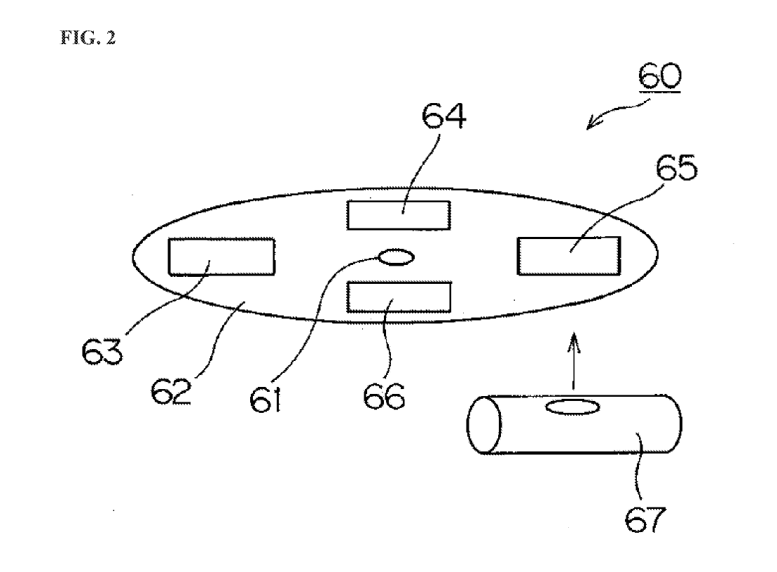

FIG. 2 is a schematic diagram illustrating a filter selecting unit 60 together with an x-ray tube 67 that are contained within an x-ray emitting unit 3.

The filter selecting unit 60 is provided with a rotating plate 62 that has a plurality of opening portions 63, 64, and 65 that are each provided with different soft radiation excluding filters, along with an opening portion 66 that has no filter. This rotating plate 62 rotates around an axle 61, driven by a motor, not shown. Filters of different materials, such as copper and aluminum, and of different thicknesses, are used as the filters that are provided in the opening portions 63, 64, and 65. The rotational angular position of the rotating plate 62 is determined by a filter controlling unit 74, described below.

Because of this, the x-rays emitted from the x-ray tube 67 are emitted towards the examination patient 2 through different filters, depending on the opening portion 63, 64, or 65 that is oriented facing the x-ray tube 67, where the rotational angular position of the rotating plate 62 is controlled by the filter controlling unit 74. Additionally, when the rotational angular position of the rotating plate 62 is controlled so that the orientation is such that the opening portion 66 faces the x-ray tube 67, the x-rays emitted from the x-ray tube 67 are emitted towards the examination patient 2 without passing through a filter.

F1G. 3 is a schematic diagram illustrating the structure of a foot switch 14. Note that the other foot switches 15 and 16 also have the same structure as the foot switch 14.

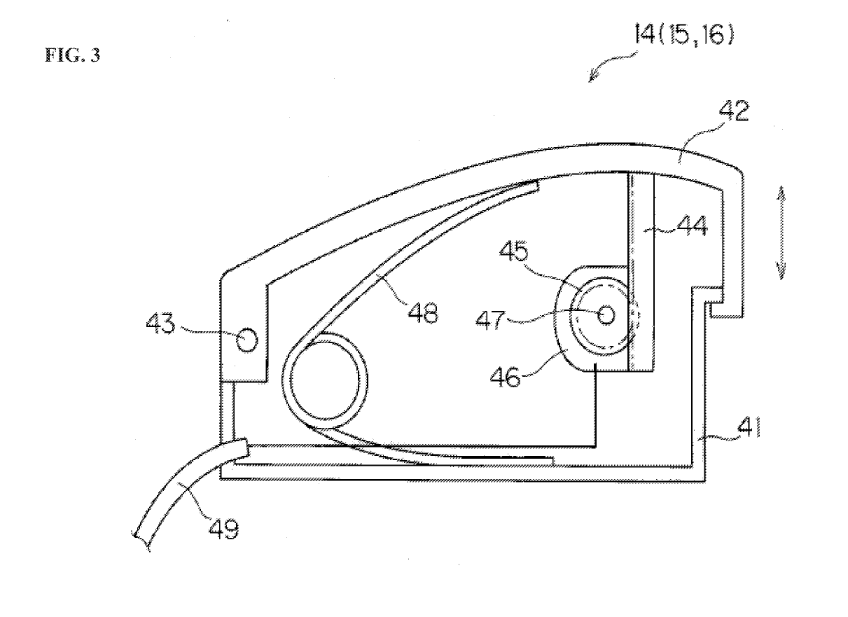

This foot switch 14 has a pedal unit 42 that pivots on an axle 43 that is disposed in a main body 41. The pedal unit 42 is pushed towards the direction that opens up from the main body 41, through the effect of a torsion spring 48 that is provided between the pedal unit 42 and the main body 41, so that one edge thereof engages with the main body, to stop in the position illustrated in FIG. 3. A rack portion 44 is provided, shaped so as to face downward, on the bottom face of the pedal unit 42. A pinion 45 engages with this rack portion 44. The pinion 45 is provided on a detecting axle 47 of a potentiometer 46.

When the operator steps on the pedal unit 42 in the foot switch 14, the magnitude of depression by this stepping is detected by the potentiometer 46 as a magnitude of movement of the rack portion 44, or in other words, as a magnitude of rotation of the pinion 45. This detected value is sent to the controlling unit 70, described below, through a cable 49.

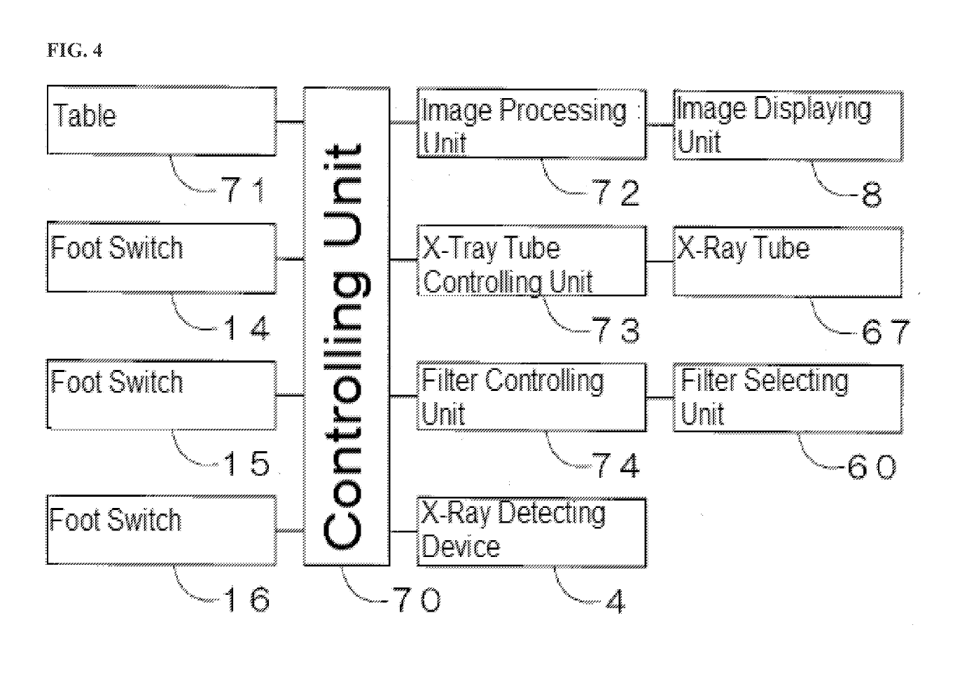

FIG. 4 is a block diagram illustrating electrical structures of an x-ray imaging device according to the present invention.

The x-ray imaging device according to an example is provided with a controlling unit 70 for controlling the device as a whole. This controlling unit 70 is connected to the aforementioned x-ray detecting device 4 and to the foot switches 14, 15, and 16. Moreover, this controlling unit 70 is connected through an image processing unit 72 to each of the monitors 11 of the image displaying unit 8 illustrated in FIG, 1. This image processing unit 72 uses video signals, based on the x-rays detected by the x-ray detecting device 4, to display an x-ray transmission image on the image displaying unit 8. Moreover, the controlling unit 70 is connected through an x-ray tube controlling unit 73 to the x-ray tube 67 (shown in FIG. 2) that is disposed within the x-ray emitting unit 3 that is illustrated in FIG. 1. Moreover, this controlling unit 70 is connected through a filter controlling unit 74 to the filter selecting unit 60 that is illustrated in FIG. 2.

Additionally, the controlling unit 70 is also connected to a table 71. This table 71 stores a plurality of x-ray imaging conditions, That is, this table 71 stores information such as information regarding the x-ray dose that is emitted towards the object to be examined, the tube voltage of the x-ray tube, the tube current of the x-ray tube, information regarding the pulse rate of the x-rays and the pulse width of the x-rays, information regarding the plurality of soft radiation excluding filters, conditions for image processing by the image processing unit 72, and the like, in relationship to the magnitudes of depression of the foot switches 14, 15, and 16.

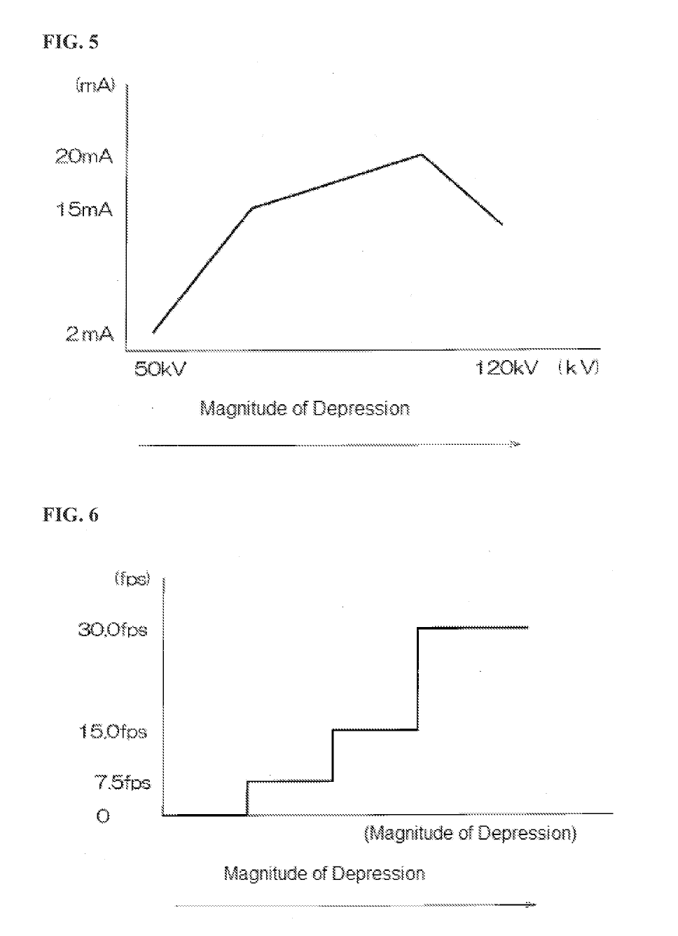

The imaging operation by the x-ray imaging device according to the example, set forth above, is explained below. An example wherein the x-ray dose on the object to be examined is varied through changing the tube voltage and tube current of the x-ray tube 67 in accordance with the type of object to be examined and the type of examination will be explained first. FIG. 5 is a graph illustrating the relationship between the magnitude of depression of the foot switch 14, 15, or 16, and the tube voltage and tube current.

As illustrated by the graph, when the magnitude of depression of the foot switch 14, 15, or 16 is increased, the tube current and tube voltage of the x-ray tube 67 is steadily increased from 2 mA-50 kv, under the control of the x-ray tube controlling unit 73, and the x-ray dose per unit time that is emitted towards the object being examined increases as well, The relationships with the tube current and tube voltage of the x-ray tube 67 at this time are stored in the table 71. If the tube current is about 20 mA, the tube current will be reduced even if the magnitude of depression of the foot switch 14, 15, or 16 is increased; however, even at this time, the x-ray dose is increased through the increase in the tube voltage. Moreover, when the magnitude of depression of the foot switch 14, 15, or 16 is reduced, then, conversely, the x-ray dose per unit time that is emitted toward the object being examined is reduced.

Because of this, when performing an examination or a treatment that requires a high-quality image, the operator operates the foot switch 14, 15, or 16 with his or her foot, to increase the magnitude of depression of the foot switch 14, 15, or 16. This increases the x-ray dose per unit time that is emitted towards the object being examined, making it possible to obtain a high quality captured image or transparent image. In contrast, when, for example, directing a catheter to a target position, the operator reduces the magnitude of depression of the foot switch 14, 15, or 16 by operating the foot switch 14, 15, or 16 with his or her foot. This makes it possible to reduce the dose with which the examination patient 2 is exposed, by reducing the x-ray dose per unit time that is emitted toward the object being examined.

Note that when the magnitude of depression of the foot switch 14, 15, or 16 is changed continuously by the operator, the magnitude of depression of the foot switch 14, 15, or 16 may be categorized into a step value, and the x-ray dose may be changed stepwise, in accordance with the magnitude of depression, rather than the x-ray dose changing continuously in accordance with the graph illustrated in FIG. 5, as in the form of embodiment explained above.

Note that, as described above, when the x-ray dose that is emitted toward the object being examined has been changed, the image that is displayed on the monitor 11 of the image displaying unit 8 will become dark. Because of this, the conditions for image processing by the image processing unit 72, in the x-ray imaging device according to the present invention, are changed in accordance with the magnitude of depression of the foot switch 14, 15, or 16. That is, if the magnitude of depression of the foot switch 14, 15, or 16 is small and the image that is displayed on the monitor 11 of the image displaying unit 8 is dark, then the conditions for image processing in the image processing unit 72 will change to display parameters such that the image on the monitor 11 becomes bright. While this increases the noise somewhat, it makes it possible to obtain adequate display quality when high image quality is not required.

A case wherein the pulse rate of the x-ray tube 67 is changed in accordance with the type of object being examined and the type of examination is explained next. FIG. 6 is a graph illustrating the relationship between the magnitude of depression of the foot switch 14, 15, or 16, and the pulse rate of the x-rays emitted from the x-ray tube.

As illustrated in this graph, when the magnitude of depression of the foot switch 14, 15, or 16 is increased, the pulse rate of the x-ray that is emitted from the x-ray tube 67 is changed stepwise under control of the x-ray controlling unit 73. That is, as the magnitude of depression of the foot switch 14, 15, or 16 is increased steadily, the pulse rate of the x-rays emitted from the x-ray tube 67 increases stepwise from 7.5 fps to 15.0 fps to 30.0 fps. information for these pulse rates is stored, in relation to the magnitudes of pressing on the foot switches 14, 15, and 16, in the table 71.

Because of this, when viewing a position wherein there is rapid motion, such as the heart, the viewing can be performed using a high pulse rate, such as 15.0 fps or, if necessary, 30.0 fps. On the other hand, when directing a catheter to the heart, the pulse rate is changed to 7.5 fps. Doing so makes it possible to reduce the dose to which the examination patient 2 is exposed.

Note that while in FIG. 6 the x-ray pulse rate is changed in a stepwise manner, the x-ray pulse rate may instead be changed continuously. Moreover, in the same way, the product of the tube current and time can be changed through modifying the pulse width of the x-rays in accordance with the magnitude of depression of the foot switch 14, 15, or 16.

A case where soft radiation excluding filters are used selectively depending on the type of object being examined and on the type of examination is described next.

As illustrated in FIG. 2, the filter selecting unit 60 is provided with a rotating plate 62 that has a. plurality of opening portions 63, 64, and 65 that are each provided with different soft radiation excluding filters, along with an opening portion 66 that has no filter. This rotating plate 62 is rotated, by a signal from the filter controlling unit 74, based on the magnitude of depression of the foot switch 14, 15, or 16. Because of this, the operator is able to execution of x-ray imaging using the most appropriate soft radiation excluding filter, or using no soft radiation excluding titter at all, depending on the thickness or position of the object being examined, or depending on the type of examination, through changing the magnitude of depression of the foot switch 14, 15, or 16. This makes it possible to perform appropriate x-ray imaging while controlling the dose to which the examination patient is exposed.

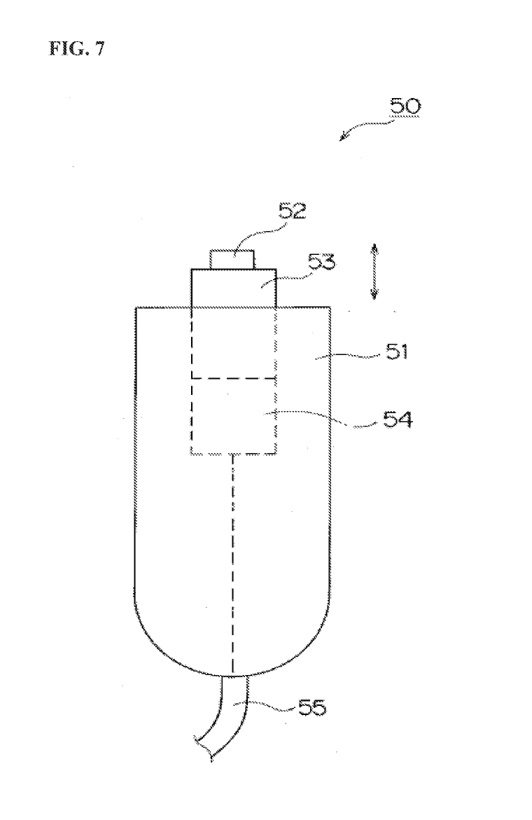

Another example is explained next. FIG. 7 is a schematic diagram of a hand switch 50 that is used in an x-ray imaging device as set forth in a second form of embodiment according to the present invention.

While in the first form of embodiment, set forth above, the operating quantity by the operator was detected using a foot switch 14, 15, or 16, in the second form of embodiment the operating quantity by the operator is detected by a hand switch 50. Moreover, white in the first form of embodiment, set forth above, the operating quantity by the operator was detected by a magnitude of depression of a foot switch 14, 15, or 16, in this example, the operating quantity by the operator is detected from a pressing force on the hand switch 50.

The hand switch 58 is provided with a grip portion 51 that is held by the hand of the operator, a start switch 52 that is provided with two positions, and a main switch 53. Preparations for x-ray imaging are made when the operator has pressed the start switch 52. Following this, the x-ray imaging is started if the operator, by continuing to apply pressure, presses the main switch 53. At this time, the pressing force on the main switch 53 by the operator is detected by a pressure gauge 54. This detected value is sent to the controlling unit 70, described below, through a cable 55.

In this example, as with the example, described above, the tube voltage and/or tube current of the x-ray tube 67 is changed to change the x-ray dose for the object being examined, or the pulse rate and/or pulse width of the x-rays emitted from the x-ray tithe 67 is changed, in accordance with the type of object being examined or the type of examination, through an operation that is similar to that in the above example, through the detection of a pressing force on the hand switch 50.

1. An x-ray imaging device, comprising an x-ray tube for emitting x-rays and an x-ray detecting device oriented facing the x-ray tube, performing x-ray imaging by detecting x-rays that pass through an object to be examined, comprising:
a detector detecting, stepwise or continuously, changes in an operating quantity by an operator at the time of x-ray imaging; and
a controller changing x-ray imaging conditions based on a detection result by the detecting means.

2. The x-ray imaging device as set forth in claim 1, wherein:
the detector is one of a foot switch or a hand switch for detecting a change in a pressing force or a magnitude of depression by an operator.

3. The x-ray imaging device as set forth in claim 2, wherein:
the controller changes, stepwise or continuously, an x-ray dose emitted toward an object being examined, based on a detection result by the detector.

4. The x-ray imaging device as set forth in claim 2, wherein:
the controller changes, stepwise or continuously, a tube voltage of an x-ray tube, a tube current of an x-ray tube, a pulse rate of an x-ray, and/or a pulse width of an x-ray, based on a detection result by the detector.

5. The x-ray imaging device as set forth in claim 2, wherein:
the controller uses selectively a plurality of soft radiation excluding filters based on a detection result by the detector.

6. The x-ray imaging device as set forth in claim 2, further comprising:
a storing device storing a plurality of x-ray imaging conditions, wherein:
the controller selects one x-ray imaging condition that is stored in the controller, based on a detection result of the detector.

7. The x-ray imaging device as set forth in claim 2, further comprising:
an image processing unit displaying an x-ray transmission image on the image displaying unit using a video signal based on x-rays detected by the x-ray detecting device; wherein:
the controller changes a condition for image processing by the image processing unit based on a detection result by the detector.
